(19) United States
(12) Patent Application Publication
(10) Pub. No.: US 2021/0326876 A1
(43) Pub. Date: Oct. 21, 2021

(54) DEDICATED BLOCKCHAIN NODE DEVICES AND BLOCKCHAIN NETWORKS

(71) Applicant: ALIPAY (HANGZHOU) INFORMATION TECHNOLOGY CO., LTD., Hangzhou (CN)

(72) Inventors: Changzheng Wei, Hangzhou (CN); Ying Yan, Hangzhou (CN); Hui Zhang, Hangzhou (CN)

(73) Assignee: ALIPAY (HANGZHOU) INFORMATION TECHNOLOGY CO., LTD., Hangzhou (CN)

(21) Appl. No.: 17/362,980

(22) Filed: Jun. 29, 2021

(30) Foreign Application Priority Data
Jul. 8, 2020 (CN) 202010652951.2

(51) Int. Cl. G06Q 20/40; G06Q 20/38; H04L 9/08; H04L 9/32

(52) U.S. Cl. CPC G06Q 20/405; G06Q 20/38215; G06Q 20/3829; H04L 2209/38; H04L 9/3263; H04L 2209/56; H04L 9/0825

(57) ABSTRACT

A smart network card included in a blockchain node device performs a transaction consensus on a first transaction with one or more nodes in a blockchain network that includes the blockchain node device, where the blockchain node device includes the smart network card, at least one central processing unit, and a smart contract processing chip. In response to a determination that the first transaction passes the transaction consensus, the smart network card sends the first transaction to the at least one central processing unit. The at least one central processing unit sends a second transaction associated with the first transaction to the smart contract processing chip, where the second transaction is used to call a smart contract. The smart contract processing chip receives the second transaction from the at least one central processing unit. The smart contract processing chip executes the smart contract.

### CROSS-REFERENCE TO RELATED APPLICATIONS

This application claims priority to Chinese Patent Application No. 202010652951.2, filed on Jul. 8, 2020, which is hereby incorporated by reference in its.

### TECHNICAL FIELD

One or more embodiments of the present disclosure relate to the field of terminal technologies, and in particular, to blockchain integrated stations and blockchain networks.

### BACKGROUND

Blockchain technology (also known as distributed ledger technology) is a decentralized distributed database technology. This technology has a plurality of characteristics such as decentralization, openness, transparency, tamper-resistance, and trustworthiness, and is applicable to many scenarios with high demands for data reliability.

### SUMMARY

In view of this, one or more embodiments of the present disclosure provide a blockchain integrated station and a blockchain network.

One or more embodiments of the present disclosure provide the following technical solutions:

According to a first aspect of one or more embodiments of the present disclosure, a blockchain integrated station is provided, where the blockchain integrated station includes a blockchain node device, and the blockchain node device includes a smart network card, a central processing unit, a smart contract processing chip, and a memory;

the smart network card is configured to perform transaction consensus with other nodes in a blockchain network to which the blockchain node device belongs, and upload the transaction that passed the consensus to the central processing unit;

the central processing unit is configured to receive the transaction uploaded by the smart network card and send the transaction for calling a smart contract to the smart contract processing chip;

the smart contract processing chip is configured to receive the transaction sent by the central processing unit and execute the smart contract called by the transaction;

the memory is configured to store blockchain data and status data.

According to a second aspect of one or more embodiments of the present disclosure, a blockchain network is provided, where the blockchain network includes a plurality of blockchain nodes formed by the blockchain integrated stations according to the first aspect.

### BRIEF DESCRIPTION OF THE DRAWINGS

FIG. 1 is a schematic structural diagram of a blockchain integrated station according to example embodiments.

FIG. 2 is a schematic structural diagram of a blockchain node device according to example embodiments.

FIG. 3 is a schematic structural diagram of an intelligent network card according to example embodiments.

FIG. 4 is a schematic structural diagram of a smart contract processing chip according to example embodiments.

FIG. 5 is a schematic structural diagram of another blockchain node device according to example embodiments.

FIG. 6 is a schematic structural diagram of a cryptographic accelerator card according to example embodiments.

FIG. 7 is a schematic structural diagram of another blockchain node device according to example embodiments.

FIG. 8 is an architecture diagram of a blockchain network according to example embodiments.

### DETAILED DESCRIPTION OF THE EMBODIMENTS

Example embodiments will be described in detail herein, and examples of the example embodiments are shown in the accompanying drawings. When the following description involves the accompanying drawings, unless otherwise indicated, the same numbers in different accompanying drawings represent the same or similar elements. The implementations described in the following example embodiments are not all the implementations consistent with one or more embodiments of the present disclosure, but are instead merely embodiments of methods and apparatuses that are described in detail in the appended claims and that are consistent with some aspects of one or more embodiments of the present disclosure.

It should be noted that in other embodiments, the steps of corresponding methods are not necessarily performed according to a sequence shown and described in the present disclosure. In some other embodiments, the methods can include more or fewer steps than those described in the present disclosure. In addition, a single step described in the present disclosure can be divided into a plurality of steps for description in other embodiments, and a plurality of steps described in the present disclosure can be combined into a single step for description in other embodiments.

In the early stage of development of the blockchain technology, users mostly add their own personal computer (PC) and laptop computer and the like into a blockchain network to become a blockchain node in the blockchain network. At this time, the stage can be called 1.0 architecture era of blockchain network, in which the behaviors of users to participate in the blockchain network are autonomous and the users also need to perform autonomous maintenance, for example, perform maintenance and configuration and so on for their devices (for example, PC) participating in the blockchain network. Along with continuous development of the blockchain technology, especially along with increasing needs of users for infrastructures with high performance and high availability, the blockchain network develops into 2.0 architecture era based on cloud service. In the 2.0 architecture era, Blockchain-as-a-Service (BaaS) provides fast and convenient solutions for fast blockchain deployment and technical implementation and supports a large number of blockchain service projects. Generally, BaaS is built on infrastructures such as public cloud or private cloud, which introduces heavy dependence on infrastructure as well as providing strong deployment capability. However, because blockchain is a typical distributed computing technology, not all nodes can be migrated to clouds but privatization deployment is needed. The additional technical migration and maintenance costs brought by the privatization deployment cause inconsistent technical interfaces and high deployment and maintenance costs during an actual implementation.

Therefore, in order to avoid the problems of inconsistent interfaces and high deployment and maintenance costs caused by privatization deployment, the present disclosure further upgrades the architecture of the blockchain network, realizing architecture 3.0 architecture era based on a blockchain integrated station.

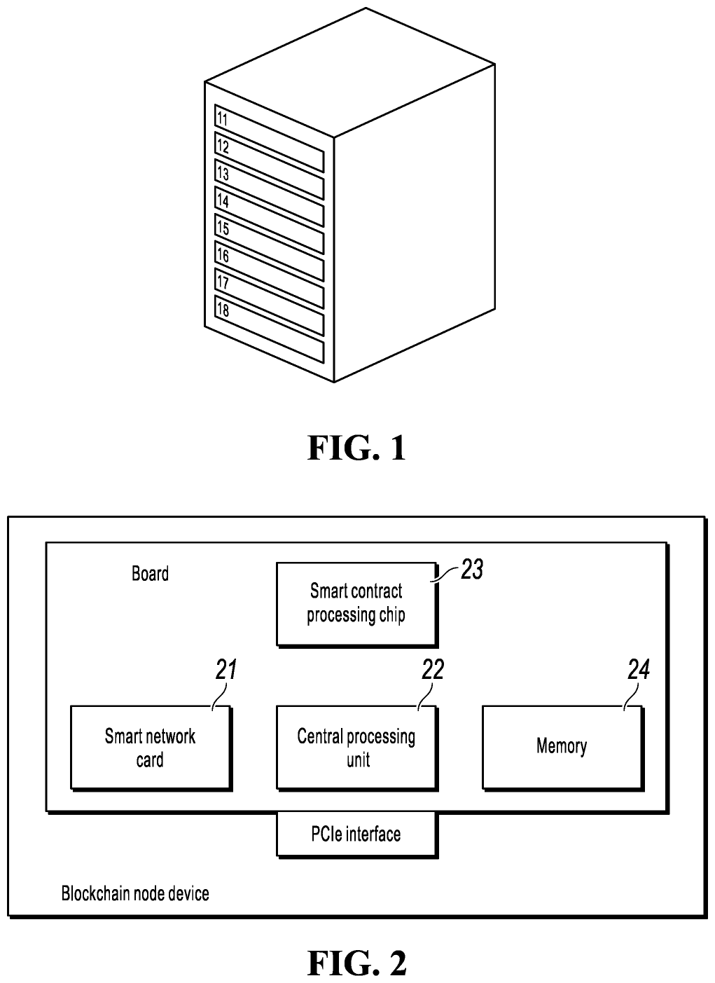

FIG. 1 is a schematic structural diagram of a blockchain integrated station according to example embodiments of the present disclosure. As shown in FIG. 1, the blockchain integrated station can include a plurality of assembly positions 11 to 18.

In the present disclosure, at least one assembly position of the blockchain integrated station is equipped with a blockchain node device. For example, the blockchain node device can be assembled at the assembly position 11 shown in FIG. 1 to form a blockchain network together with blockchain node devices in other blockchain integrated stations. Certainly, this is merely an example, and the blockchain integrated station can be equipped with either only one blockchain node device or a plurality of blockchain node devices. If the blockchain integrated station is equipped with only one blockchain node device, each blockchain node in the blockchain network corresponds to a respective blockchain integrated station. If the blockchain integrated station is equipped with a plurality of blockchain node devices, the blockchain integrated station includes a plurality of blockchain nodes included in the blockchain network.

In the present disclosure, both the hardware and the software of the blockchain node device equipped in the blockchain integrated station are optimized. The following describes the structure of the blockchain node device.

FIG. 2 is a schematic structural diagram of a blockchain node device according to example embodiments. As shown in FIG. 2, the blockchain node device includes a smart network card 21, a central processing unit 22, a smart contract processing chip 23, and a memory 24.

The smart network card 21 is configured to perform transaction consensus with other nodes in a blockchain network to which the blockchain node device belongs, and upload the transaction that passed the consensus to the central processing unit 22.

The central processing unit 22 is configured to receive the transaction uploaded by the smart network card 21 and send the transaction for calling a smart contract to the smart contract processing chip 23.

The smart contract processing chip 23 is configured to receive the transaction sent by the central processing unit 22 and execute the smart contract called by the transaction.

The memory 24 is configured to store blockchain data and status data.

In the present disclosure, the smart network card 21 cannot only implement functions of a traditional network card, but also can replace or assist the central processing unit 22 of the blockchain integrated station to complete part of functions. For example, the smart network card 21 can perform transaction consensus with other nodes in the blockchain network to which the blockchain node device belongs, and upload the transaction that passed the consensus to the central processing unit 22. That is, the function of transaction consensus that was in the central processing unit 22 is offloaded to the smart network card 21.

Compared with other components in the blockchain node device, especially the central processing unit 22, the smart network card 21 is closer to the network in physical level and logic level, so that the smart network card 21 always receives transactions transmitted in the network first. Therefore, the smart network card 21 is used to perform transaction consensus in the case of no memory access or a small amount of memory access is involved, so that the central processing unit 22 does not need to directly participate in the process of consensus. This can significantly improve the efficiency of the consensus.

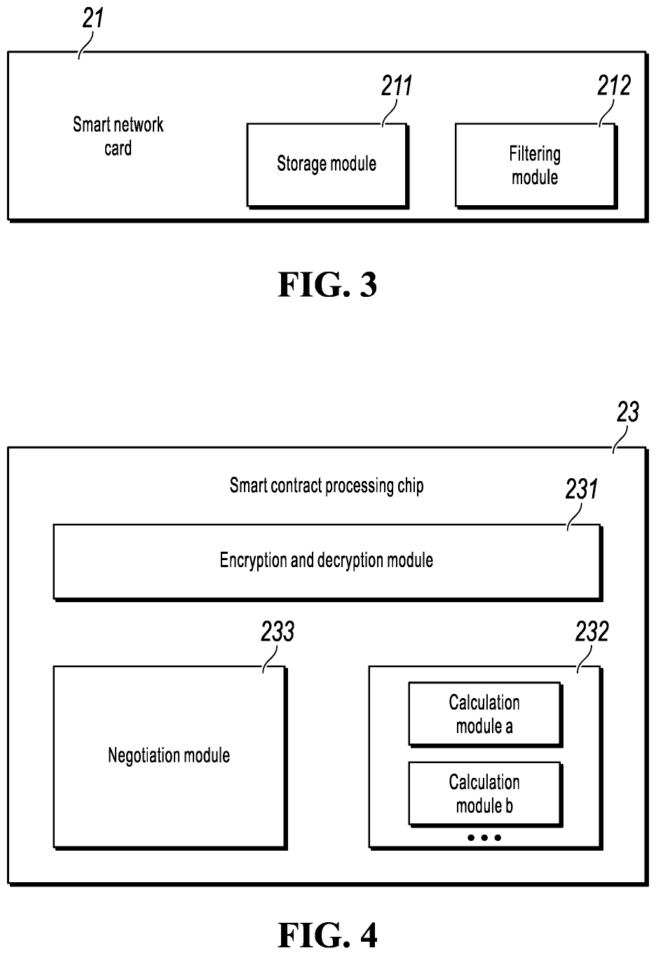

The smart network card 21 can also filter received transactions. Specifically, the smart network card 21 can include a storage module 211 and a filtering module 212 shown in FIG. 3. The storage module 211 is configured to record a transaction filtering rule; the filtering module 212 is electrically connected to the storage module 211 and is configured to read the transaction filtering rule recorded in the storage module 211, and perform filtering after parsing the received transactions based on the transaction filtering rule, so that the filtered transaction participates in the transaction consensus.

The filtering rule stored in the storage module 211 can be filtering out replay transactions. For example, when receiving a transaction, the filtering module 212 can compare the transaction with historical transactions, for example, compare fields such as transmitted information, destination address, timestamp, hash value, so as to identify and filter out replay transactions. Alternatively, the filtering rule can be filtering out illegal transactions or predefined types of transactions. For example, the filtering module 212 can parse contents of received transactions to identify illegal transactions and/or predefined types of transactions, and then filter out such transactions.

The smart contract processing chip 23 in the present disclosure can include an encryption and decryption module 231 and a calculation module 232 shown in FIG. 4. The calculation module 232 is electrically connected to the encryption and decryption module 231 and the central processing unit 22. The encryption and decryption module 231 is configured to: in a case that the transaction sent by the central processing unit 22 is a ciphertext transaction, decrypt the ciphertext transaction by using a node private key of the blockchain node device and send plaintext transaction content obtained after the decryption to the calculation module 232, so that the calculation module 232 executes a smart contract called by the plaintext transaction content after receiving the plaintext transaction content. After the smart contract is executed, the calculation module 232 returns a contract status value to the encryption and decryption module 231, so that the encryption and decryption module 231 encrypts the returned contract status value by using a service key. Correspondingly, the calculation module 232 is also configured to: in a case that the transaction sent by the central processing unit 22 is a plaintext transaction, execute a smart contract called by the plaintext transaction.

The smart contract processing chip 23 can further include a negotiation module 233 shown in FIG. 4. The negotiation module 233 is configured to generate negotiation information, and the negotiation information is used for generating a file deployment key and a service secret deployment key through negotiation.

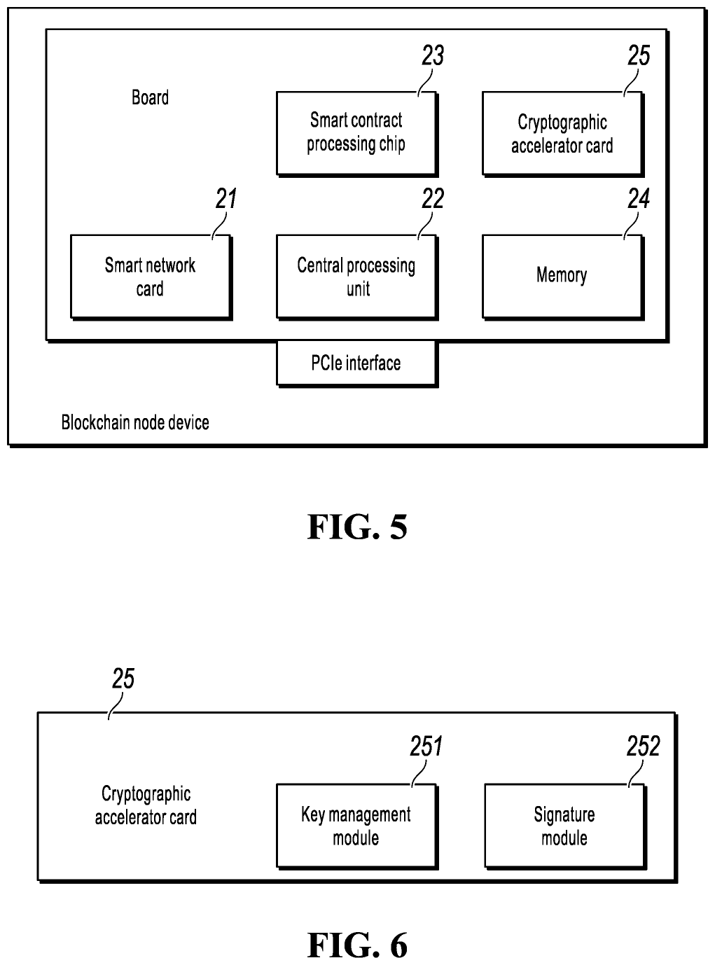

As shown in FIG. 5, the blockchain node device can further include a cryptographic accelerator card 25. The cryptographic accelerator card 25 can implement a fully encrypted memory, defend against side channel attacks through hardware reinforcement, and implement physical protection against approaches such as probes, lasers, and the like. Therefore, the cryptographic accelerator card has very high security. For example, the cryptographic accelerator card 25 used in the blockchain integrated station can have level-2, level-3 qualification from the State Cryptography Administration 2, or the like.

Specifically, the cryptographic accelerator card 25 can include a key management module 251 and a signature module 252 shown in FIG. 6. The key management module 251 is configured to maintain a root of trust key; and the signature module 252 is electrically connected to the key management module 251, the negotiation module 233, and the smart network card 21, and is configured to read the root of trust key and sign the negotiation information, and send the signed negotiation information to a provider of the blockchain integrated station via the smart network card 21, so that the provider deploys a binary image file corresponding to the blockchain node device on the blockchain integrated station by using the file deployment key obtained through negotiation, and deploys the node private key and the service key on the smart contract processing chip 23 by using the service secret deployment key obtained through negotiation. In other words, the cryptographic accelerator card 25 can replace the smart contract processing chip 23 to complete the operations such as information encryption and key negotiation. In addition to ensuring security, the cryptographic accelerator card 25 can also offload tasks from the smart contract processing chip 23 to improve the processing efficiency.

It should be stated that in actual operations, the key negotiation, the deployment of the binary image file, and the deployment of the node private key and the service key are usually three independent processes. Specifically, the blockchain node device can perform key negotiation with the provider of the blockchain integrated station based on the negotiation information to obtain the file deployment key and the service secret key, and deploy the file deployment key and the service secret key to the smart contract processing chip 23. Based on this, the provider can send the binary image file encrypted by using the file deployment key to the smart contract processing chip 23. The smart contract processing chip 23 can decrypt the encrypted binary image file based on the file deployment key obtained through negotiation in advance, so as to deploy the binary image file obtained through decryption. Further, after updating the binary image file, the provider can send the updated binary image file to the smart contract processing chip 23 by using the file deployment key, so that the smart contract processing chip 23 can re-deploy the binary image file. Correspondingly, the provider can encrypt the node private key and the service key of the blockchain node by using the service secret deployment key, and send the node private key and the service key to the smart contract processing chip 23, so that the smart contract processing chip 23 decrypts the node private key and the service key by using the service secret deployment key and deploys the node private key and the service key locally.

After the node private key and the service key are deployed in the smart contract processing chip 23 in the previous-mentioned method, a private transaction needs in a blockchain scenario can be satisfied. For example, the node private key corresponds to a node public key, a client device can encrypt and transmit a blockchain transaction by using the node public key, and the blockchain node device can decrypt the blockchain transaction by using the node private key. The service key is a symmetric key, which can be used to encrypt and store service data such as contract code and contract status values. The service key cannot be used directly, and the smart contract processing chip 23 can encrypt and decrypt the service key by using a derived key of the service key, to reduce a security risk of the service key. Through reliable management for the node private key and the service root key (or its derivation key), data will be always in encrypted state unless processed by the smart contract processing chip 23. Therefore, the smart contract processing chip 23 actually forms a Trusted Execution Environment (TEE) of hardware on the blockchain integrated station, so as to ensure the data requiring privacy protection such as transactions, contract codes, and contract statuses will not be leaked.

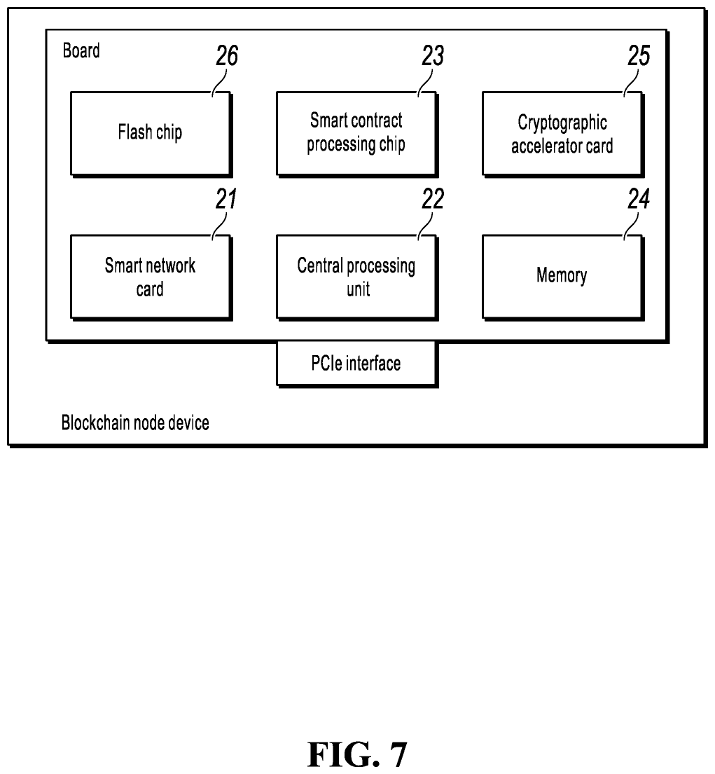

In the present disclosure, the smart contract processing chip 23 is obtained by configuring a field-programmable gate array (FPGA) chip according to a predefined circuit logic configuration file, so as to improve the processing efficiency specific for the smart contract. However, the FPGA chip is volatile, and the deployed circuit logic configuration file will be lost after a power-off, the circuit logic configuration file needs to be re-deployed in the FPGA after a power-on. Therefore, a flash chip 26 shown in FIG. 7 is also configured on the blockchain node device, to store the circuit logic configuration file, so that the FPGA chip 26 can be configured as the smart contract processing chip 23 by using the circuit logic configuration file stored by the flash chip 26 after each power-on.

In order to further improve the execution efficiency of the smart contract, the smart contract processing chip 23 can include a plurality of calculation modules, for example, a calculation module a, and a calculation module b shown in FIG. 4, so that the smart contract processing chip 23 can execute a plurality of smart contracts called by different transactions in parallel to improve the contract execution efficiency.

In the present disclosure, the smart network card 21, the central processing unit 22, the smart contract processing chip 23, the memory 24, the cryptographic accelerator card 25 and the flash chip 26 can all be assembled on a board, and the board can be connected to the blockchain node device through a PCIE interface. The board can be an FPGA board or another type of board, which is not limited in the present disclosure.

It can be seen from the above-mentioned technical solutions that the blockchain node device in the present disclosure is equipped with the smart network card and the smart contract processing chip in addition to traditional components such as the central processing unit and the memory. When the blockchain node device receives transaction, the smart network card closer to the network side performs transaction consensus, so that the central processing unit does not need to directly participate in the transaction consensus, which reduces the processing resources occupied by the central processing unit while improving the consensus efficiency. The smart contract is not executed by a traditional blockchain node device like the central processing unit, but is executed by the smart contract processing chip, which not only improves the execution efficiency of the smart contract, but also reduces the resources occupied by the central processing unit.

Further, the blockchain node device is further equipped with the cryptographic accelerator card. The cryptographic accelerator card maintains the root of trust key, so that the smart contract processing chip is capable of performing key negotiation with the provider of the blockchain integrated station by using the cryptographic accelerator card to obtain the file deployment key and the service secret deployment key. On one hand, the smart contract processing chip can obtain the binary image file from the provider based on the file deployment key; on the other hand, the smart contract processing chip can obtain the node private key and the service key for data encryption and decryption by using the service secret deployment key. In other words, by deploying the cryptographic accelerator card, the blockchain node device can proactively deploy the binary image file to form blockchain nodes, and proactively obtain keys for service transmission, thereby realizing encrypted transmission of data.

Further, by assembling the blockchain node device in the blockchain integrated station, the blockchain integrated station can form, based on the blockchain node device, a blockchain network with blockchain node devices in other blockchain integrated stations, so that users can obtain corresponding software code while obtaining the blockchain integrated station from the provider, without deploying blockchain nodes, realizing the integration of software and hardware.

In addition to the blockchain node device, the blockchain integrated station in the present disclosure can also be equipped with other devices to satisfy different needs of users.

It should be understood that the blockchain node device is configured to: if the transaction is received and the transaction passed consensus, execute the smart contract called by the transaction. In this process, external data may need to be called. For example, transactions stored in or smart contracts deployed in blockchain networks different than the blockchain network to which the blockchain node device belongs need to be called, and data stored in an off-chain remote server need to be called.

Therefore, the blockchain integrated station can also be equipped with a cross-chain proxy server. For example, the cross-chain proxy server can be assembled at an assembly position 12 shown in FIG. 1 to satisfy the needs for external data access. Specifically, when receiving an external data access request initiated by the blockchain node device, the cross-chain proxy server can access a target blockchain network or a remote server, so as to send data to the target blockchain network or the remote server and/or return an access result to the blockchain node device.

In the present disclosure, the blockchain integrated station can also be equipped with an off-chain computing node device. For example, the off-chain computing node device can be assembled at an assembly position 13 shown in FIG. 1, and a plurality of off-chain contracts are pre-deployed in the off-chain computing node device for the blockchain node device to call. Based on this, the off-chain computing node device can respond to an off-chain contract calling request initiated by the blockchain node device to execute an off-chain contract indicated by the off-chain contract calling request, and return an execution result of the off-chain contract to the blockchain node device.

Assembling the off-chain computing node device in the blockchain integrated station enables the blockchain node device to distribute computing tasks to the off-chain computing node devices, so that the blockchain node devices can have more processing resources to execute the smart contract, which improves the contract execution efficiency of the blockchain node device.

In actual applications, the blockchain node device can distribute the computing tasks in various manners. For example, in one case, computing tasks of a predetermined type can be distributed to the off-chain computing node device. In this case, when the blockchain node device needs to execute computing tasks of the predetermined type, the off-chain contract in the off-chain computing node device can be called. In another case, under the condition that the processing resources in the blockchain node device are all occupied, the overflow computing tasks can be executed by calling the off-chain contract in the off-chain computing node device. Certainly, this is merely an example, and a person skilled in the art can determine a method of distributing the computing tasks according to the actual situation, which is not limited in the present disclosure.

A certificate authority device can also be assembled in the blockchain integrated station. For example, the certificate authority device can be assembled at an assembly position 14 shown in FIG. 1. After the certificate authority device is enabled, an embedded certificate authority service can be started, so as to generate a root certificate for issuing digital certificates. Based on this, after receiving an authentication request initiated by the blockchain node device, the certificate authority device can verify the authentication request, and send a digital certificate to the blockchain node device by using the root certificate if the authentication request passes verification.

By assembling the certificate authority device, the digital certificate authority service is embedded in the blockchain integrated station, which can implement automatic issuance of digital certificates and automatic authentication of node identities, so that the blockchain integrated station can automatically build a blockchain and the blockchain nodes can automatically join the blockchain, implementing plug-and-play of the blockchain integrated station.

In the present disclosure, the hardware of the blockchain node device in the blockchain integrated station can be optimized on the basis of the structure of the blockchain integrated station, and the integration of software and hardware can be implemented by deploying corresponding software in the blockchain node device.

On the basis of the blockchain integrated station, the present disclosure further discloses a blockchain network.

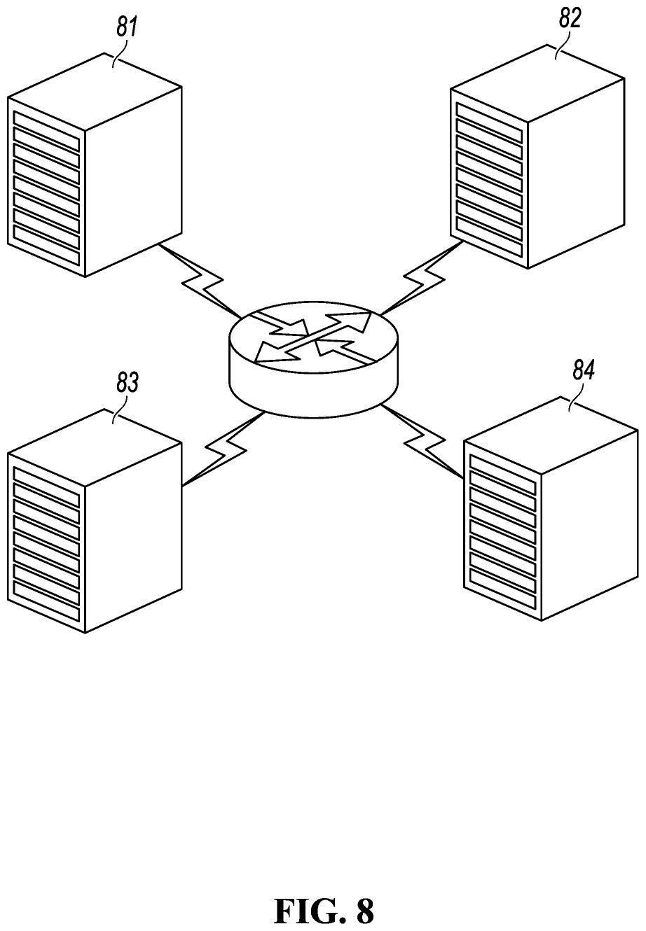

FIG. 8 is a schematic diagram of a blockchain network according to example embodiments. As shown in FIG. 8, the blockchain network includes a plurality of blockchain nodes formed by the above-mentioned blockchain integrated stations.

It should be understood that although only four blockchain integrated stations numbered 81 to 84 are shown in FIG. 8, in actual applications, the blockchain network can include more or fewer blockchain integrated stations.

The manner of processing a transaction in the blockchain node device included in the blockchain integrated station in this embodiment is similar to that in the previous embodiment, and will not be described in detail in this embodiment.

In this embodiment, each blockchain integrated station can include only one blockchain node device. In this case, each blockchain integrated station serves as one blockchain node in the blockchain network. For example, the blockchain integrated stations 81 to 84 shown in FIG. 8 only serve as one blockchain node in the blockchain network.

In this embodiment, each blockchain integrated station can also include a plurality of blockchain node devices. In other words, one blockchain integrated station in this embodiment can serve as a plurality of blockchain nodes in the blockchain network, that is, the plurality of blockchain node devices included in the blockchain integrated station form a blockchain node. For example, the blockchain integrated station 81 shown in FIG. 8 can include three blockchain node devices, and a binary image file developed by the provider of the blockchain integrated station is deployed in each of the three blockchain node devices. Therefore, three blockchain nodes in the blockchain network shown in FIG. 8 are formed.

The blockchain nodes included in the blockchain network in this embodiment can adopt a proof of work (POW) mechanism to perform transaction consensus, or adopt a Practical Byzantine Fault Tolerance (PBFT) mechanism to perform transaction consensus, which is not limited in the present disclosure.

In actual applications, users that need to build a blockchain network can purchase the blockchain integrated station through negotiation. After the purchased blockchain integrated station is powered on, each blockchain integrated station can proactively deploy a blockchain binary image file to form blockchain nodes, and then build the blockchain network together with other blockchain integrated stations.

It can be seen that through the blockchain integrated station in the present disclosure, users do not need not deploy code for a blockchain, as in the related art, after purchasing hardware. Instead, users only need to power on the blockchain integrated station and access the network to build a blockchain network together with blockchain nodes formed by the blockchain integrated stations with the same configuration purchased by other users. This implements the integration of software and hardware, and improves the deployment efficiency on the basis of satisfying the needs of users for deploying private blockchains.

The present disclosure is intended to cover any variations, uses, or adaptations of the present disclosure following the general principles thereof and including such departures from the present disclosure as come within known or customary practice in the art. It is intended that the present disclosure and examples be considered as examples only, with a true scope and spirit of the present disclosure being indicated by the claims below.

The above-mentioned descriptions are merely preferred embodiments of the present disclosure, but are not intended to limit the present disclosure. Any modification, equivalent replacement, or improvement made without departing from the spirit and principle of the present disclosure shall fall within the protection scope of the present disclosure.

What is claimed is:

1. A blockchain integrated station comprising a blockchain node device, the blockchain node device comprising:
a smart network card to:
perform a transaction consensus on a first transaction with one or more nodes in a blockchain network that comprises the blockchain node device; and
in response to a determination that the first transaction passes the transaction consensus, send the first transaction to at least one central processing unit;
the at least one central processing unit to:
receive the first transaction from the smart network card; and
send a second transaction associated with the first transaction to a smart contract processing chip, wherein the second transaction is used to call a smart contract; and
the smart contract processing chip to:
receive the second transaction from the at least one central processing unit; and
execute the smart contract.

2. The blockchain integrated station of claim 1, wherein the smart network card comprises:
a memory to store a transaction filtering rule; and
a filter connected to the memory to:
read the transaction filtering rule from the memory; and
parse the first transaction based on the transaction filtering rule before performing the transaction consensus.

3. The blockchain integrated station of claim 1, wherein the smart contract processing chip comprises:
an encryptor/decryptor to:
in response to a determination that the second transaction is a ciphertext transaction, decrypt the ciphertext transaction by using a node private key of the blockchain node device to obtain a plaintext transaction; and
encrypt a contract status value associated with the smart contract called by the ciphertext transaction by using a service key; and
a calculator connected to the at least one central processing unit and the encryptor/decryptor to:
receive the plaintext transaction from the encryptor/decryptor;
call the smart contract corresponding to the plaintext transaction; and
send the contract status value to the encryptor/decryptor for encryption.

4. The blockchain integrated station of claim 3, wherein:
the smart contract processing chip comprises a negotiator to generate negotiation information, wherein the negotiation information is used to generate a file deployment key and a service secret deployment key through negotiation; and
the blockchain node device comprises a cryptographic accelerator card, wherein the cryptographic accelerator card comprises:
a key manager to maintain a root of trust key; and
a signature module connected to the key manager, the negotiator, and the smart network card to:
read the root of trust key;
sign the negotiation information using the root of trust key to generate signed negotiation information; and
send the signed negotiation information to a provider of the blockchain integrated station via the smart network card, wherein the provider sends a binary image file corresponding to the blockchain node device by using the file deployment key and sends the node private key and the service key to the smart contract processing chip by using the service secret deployment key.

5. The blockchain integrated station of claim 1, comprising an off-chain computing node device to:
in response to an off-chain contract calling request initiated by the blockchain node device, execute an off-chain contract indicated by the off-chain contract calling request; and
return an execution result of the off-chain contract to the blockchain node device, wherein the off-chain contract is stored in the off-chain computing node device.

6. The blockchain integrated station of claim 1, comprising a cross-chain proxy server to, in response to an external data access request initiated by the blockchain node device, perform at least one of:
accessing a target blockchain network or a remote server to send data to the target blockchain network or the remote server; or
returning an access result to the blockchain node device.

7. The blockchain integrated station of claim 1, comprising a certificate authority device to:
in response to an authentication request initiated by the blockchain node device, verify the authentication request; and
in response to determining the authentication request passes verification, send a digital certificate to the blockchain node device by using a root certificate, wherein the root certificate is generated based on a certificate authority service started by the certificate authority device.

8. A computer-implemented method comprising:
performing, by a smart network card comprised in a blockchain node device, a transaction consensus on a first transaction with one or more nodes in a blockchain network that comprises the blockchain node device, wherein the blockchain node device is comprised in a blockchain integrated station, wherein the blockchain node device comprises the smart network card, at least one central processing unit, and a smart contract processing chip;
in response to a determination that the first transaction passes the transaction consensus, sending, by the smart network card, the first transaction to the at least one central processing unit;
receiving, by the at least one central processing unit, the first transaction from the smart network card; and
sending, by the at least one central processing unit, a second transaction associated with the first transaction to the smart contract processing chip, wherein the second transaction is used to call a smart contract;
receiving, by the smart contract processing chip, the second transaction from the at least one central processing unit; and
executing, by the smart contract processing chip, the smart contract.

9. The computer-implemented method of claim 8, wherein the smart network card comprises a memory and a filter connected to the memory, and wherein the computer-implemented method comprises:
storing, by the memory, a transaction filtering rule;
reading, by the filter, the transaction filtering rule from the memory; and
parsing, by the filter, the first transaction based on the transaction filtering rule before performing the transaction consensus.

10. The computer-implemented method of claim 8, wherein the smart contract processing chip comprises an encryptor/decryptor and a calculator connected to the at least one central processing unit and the encryptor/decryptor, and wherein the computer-implemented method comprises:
in response to a determination that the second transaction is a ciphertext transaction, decrypting, by the encryptor/decryptor, the ciphertext transaction by using a node private key of the blockchain node device to obtain a plaintext transaction; and
encrypting, by the encryptor/decryptor, a contract status value associated with the smart contract called by the ciphertext transaction by using a service key; and
receiving, by the calculator, the plaintext transaction from the encryptor/decryptor;
calling, by the calculator, the smart contract corresponding to the plaintext transaction; and
sending, by the calculator, the contract status value to the encryptor/decryptor for encryption.

11. The computer-implemented method of claim 10, wherein the smart contract processing chip comprises a negotiator, wherein the blockchain node device comprises a cryptographic accelerator card, wherein the cryptographic accelerator card comprises a key manager and a signature module connected to the key manager, the negotiator, and the smart network card, and wherein the computer-implemented method comprises:
generating, by the negotiator, negotiation information, wherein the negotiation information is used to generate a file deployment key and a service secret deployment key through negotiation;
maintaining, by the key manager, a root of trust key;
reading, by the signature module, the root of trust key;
signing, by the signature module, the negotiation information using the root of trust key to generate signed negotiation information; and
sending, by the signature module, the signed negotiation information to a provider of the blockchain integrated station via the smart network card, wherein the provider sends a binary image file corresponding to the blockchain node device by using the file deployment key and sends the node private key and the service key to the smart contract processing chip by using the service secret deployment key.

12. The computer-implemented method of claim 8, wherein the blockchain integrated station comprises an off-chain computing node device, and wherein the computer-implemented method comprises:
in response to an off-chain contract calling request initiated by the blockchain node device, executing, by the off-chain computing node device, an off-chain contract indicated by the off-chain contract calling request; and
returning, by the off-chain computing node device, an execution result of the off-chain contract to the blockchain node device, wherein the off-chain contract is stored in the off-chain computing node device.

13. The computer-implemented method of claim 8, wherein the blockchain integrated station comprises a cross-chain proxy server, and wherein the computer-implemented method comprises:
in response to an external data access request initiated by the blockchain node device, performing, by the cross-chain proxy server, at least one of:
accessing a target blockchain network or a remote server to send data to the target blockchain network or the remote server; or
returning an access result to the blockchain node device.

14. The computer-implemented method of claim 8, wherein the blockchain integrated station comprises a certificate authority device, and wherein the computer-implemented method comprises:
in response to an authentication request initiated by the blockchain node device, verifying, by the certificate authority device, the authentication request; and
in response to determining the authentication request passes verification, sending, by the certificate authority device, a digital certificate to the blockchain node device by using a root certificate, wherein the root certificate is generated based on a certificate authority service started by the certificate authority device.

15. A computer-implemented system comprising:
one or more blockchain integrated stations; and
one or more computer memory devices coupled with the one or more blockchain integrated stations and having tangible, non-transitory, machine-readable media storing one or more instructions that, when executed by the one or more blockchain integrated stations, perform one or more operations comprising:
performing, by a smart network card comprised in a blockchain node device, a transaction consensus on a first transaction with one or more nodes in a blockchain network that comprises the blockchain node device, wherein the blockchain node device is comprised in a blockchain integrated station, wherein the blockchain node device comprises the smart network card, at least one central processing unit, and a smart contract processing chip;
in response to a determination that the first transaction passes the transaction consensus, sending, by the smart network card, the first transaction to the at least one central processing unit;
receiving, by the at least one central processing unit, the first transaction from the smart network card; and
sending, by the at least one central processing unit, a second transaction associated with the first transaction to the smart contract processing chip, wherein the second transaction is used to call a smart contract;
receiving, by the smart contract processing chip, the second transaction from the at least one central processing unit; and
executing, by the smart contract processing chip, the smart contract.

16. The computer-implemented system of claim 15, wherein the smart network card comprises a memory and a filter connected to the memory, and wherein the operations comprise:
storing, by the memory, a transaction filtering rule;
reading, by the filter, the transaction filtering rule from the memory; and
parsing, by the filter, the first transaction based on the transaction filtering rule before performing the transaction consensus.

17. The computer-implemented system of claim 15, wherein the smart contract processing chip comprises an encryptor/decryptor and a calculator connected to the at least one central processing unit and the encryptor/decryptor, and wherein the operations comprise:
in response to a determination that the second transaction is a ciphertext transaction, decrypting, by the encryptor/decryptor, the ciphertext transaction by using a node private key of the blockchain node device to obtain a plaintext transaction; and
encrypting, by the encryptor/decryptor, a contract status value associated with the smart contract called by the ciphertext transaction by using a service key; and
receiving, by the calculator, the plaintext transaction from the encryptor/decryptor;
calling, by the calculator, the smart contract corresponding to the plaintext transaction; and
sending, by the calculator, the contract status value to the encryptor/decryptor for encryption.

18. The computer-implemented system of claim 17, wherein the smart contract processing chip comprises a negotiator, wherein the blockchain node device comprises a cryptographic accelerator card, wherein the cryptographic accelerator card comprises a key manager and a signature module connected to the key manager, the negotiator, and the smart network card, and wherein the operations comprise:
generating, by the negotiator, negotiation information, wherein the negotiation information is used to generate a file deployment key and a service secret deployment key through negotiation;
maintaining, by the key manager, a root of trust key;
reading, by the signature module, the root of trust key;
signing, by the signature module, the negotiation information using the root of trust key to generate signed negotiation information; and
sending, by the signature module, the signed negotiation information to a provider of the blockchain integrated station via the smart network card, wherein the provider sends a binary image file corresponding to the blockchain node device by using the file deployment key and sends the node private key and the service key to the smart contract processing chip by using the service secret deployment key.

19. The computer-implemented system of claim 15, wherein the blockchain integrated station comprises an off-chain computing node device, and wherein the operations comprise:
in response to an off-chain contract calling request initiated by the blockchain node device, executing, by the off-chain computing node device, an off-chain contract indicated by the off-chain contract calling request; and
returning, by the off-chain computing node device, an execution result of the off-chain contract to the blockchain node device, wherein the off-chain contract is stored in the off-chain computing node device.

20. The computer-implemented system of claim 15, wherein the blockchain integrated station comprises a cross-chain proxy server, and wherein the operations comprise:
in response to an external data access request initiated by the blockchain node device, performing, by the cross-chain proxy server, at least one of:
accessing a target blockchain network or a remote server to send data to the target blockchain network or the remote server; or
returning an access result to the blockchain node device.
